(19) United States
(12) Patent Application Publication
(10) Pub. No.: US 2026/0298811 A1
(43) Pub. Date: Oct. 1, 2026

(54) DATA PROCESSING DEVICE OF MEASUREMENT DEVICE, DATA PROCESSING METHOD, SPECTROPHOTOMETER SYSTEM, AND CHROMATOGRAPH

(71) Applicant: HITACHI HIGH-TECH ANALYSIS CORPORATION, Tokyo (JP)

(72) Inventors: Atsuki MORISAKI, Tokyo (JP); Masato FUKUDA, Tokyo (JP); Masahito ITO, Tokyo (JP)

(21) Appl. No.: 19/577,154

(22) Filed: Mar. 24, 2026

(30) Foreign Application Priority Data
Mar. 26, 2025 (JP) 2025-052533

(51) Int. Cl. G01N 21/31

(52) U.S. Cl. CPC G01N 21/31

(57) ABSTRACT

An objective is to obtain a regression curve corresponding more closely to a true spectrum. To this end, a data processing device, which performs data processing on the basis of plot data measured corresponding to a variable that is a wavelength or a time axis, includes a partial regression curve calculation unit configured to obtain a plurality of partial regression curves that are partial regression curves respectively for a plurality of partial variable ranges that are some ranges of the variables, and an integrated regression curve calculation unit configured to obtain an integrated regression curve for a variable range wider than the partial variable ranges on the basis of the obtained plurality of partial regression curves.

### CROSS REFERENCE TO RELATED APPLICATION

The present application claims priority to Japanese Patent Applications No. JP 2025-52533, filed Mar. 26, 2025, the entire contents of which are incorporated herein for all purposes by this reference.

### BACKGROUND

### Technical Field

The present disclosure relates to a data processing device of a measurement device, which obtains a regression curve on the basis of plot data such as spectra measured by a spectrophotometer or measured chromatograms, a data processing method, a spectrophotometer system, and a chromatograph.

### Description of the Related Art

In spectroscopic devices, data points of measured spectra generally involve errors (uncertainties) primarily in the vertical axis direction, so, in order to obtain a true spectrum by eliminating such errors, a technique of continuously fitting multiple spline curves to the spectral data is known (see, for example, Patent Document 1).

### (Prior Art Document)

### (Patent Document)

(Patent Document 1) Japanese Patent Publication (Unexamined) No. 2022-504948

### SUMMARY

The method using spline curves as described above merely interpolates a spectral waveform using spline curves, so errors may remain. Therefore, it is difficult to obtain an appropriate a regression curve such as a spectral curve.

The present disclosure has been made in view of the above points, and an objective of the present disclosure is to facilitate obtaining a regression curve based on a more accurate chromatogram or spectrum.

In order to achieve the objectives, The present disclosure provides a data processing device of a measurement device, which performs data processing on the basis of plot data measured corresponding to a variable that is a wavelength or a time axis, the data processing device including: a partial regression curve calculation unit configured to obtain a plurality of partial regression curves that are partial regression curves respectively for a plurality of partial variable ranges that are some ranges of the variables; and an integrated regression curve calculation unit configured to obtain an integrated regression curve for a variable range wider than the partial variable ranges on the basis of the obtained plurality of partial regression curves.

Since partial regression curves are obtained for plot data of partial variable ranges, it is possible to obtain regression curves relatively quickly and easily, and at the same time, to obtain regression curves closer to the truth.

According to the present disclosure, it is possible to easily obtain regression curves corresponding more closely to a true spectrum.

### BRIEF DESCRIPTION OF THE DRAWINGS

FIG. 1 is a block diagram illustrating a schematic configuration of a spectrophotometer system.

FIG. 2 is a block diagram illustrating a schematic configuration of the control device of a spectrophotometer.

FIG. 3 is a diagram illustrating an example of plot data of a measured spectrum.

FIG. 4 is a diagram illustrating an example of obtaining a partial regression curve.

FIG. 5 is a diagram illustrating an example of discarding an outlier.

FIG. 6 is a diagram illustrating a connecting method of PCF and an intermediate curve.

FIG. 7 is a diagram illustrating a scanning-type PCF method.

### DETAILED DESCRIPTION

Hereinafter, as an embodiment of the present disclosure, an example of a spectrophotometer system is described in detail with reference to the drawings.

### Overall Description

### (Configuration of Spectrophotometer System (100))

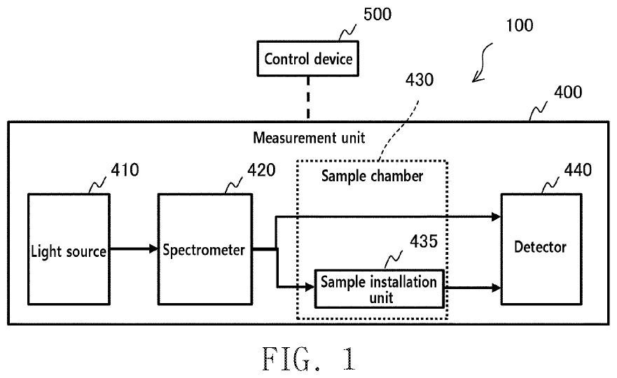

FIG. 1 illustrates a schematic configuration of the spectrophotometer system 100. The spectrophotometer system 100 includes a measurement unit 400 and a control device 500.

The measurement unit 400 is an example of a general double-beam type spectrophotometer. White light from a light source 410 is dispersed in wavelength by a spectrometer 420, such as a diffraction grating, a prism, or a filter, and the wavelength scanning is performed by controlling the angular position of the diffraction grating. After being filtered into monochromatic light by a filter, the optical path is split by a beam splitter or a sector mirror. As the light source 410, a tungsten-iodine lamp or a xenon flash lamp may be used.

Monochromatic light of a specified wavelength is split into the luminous flux of each of a sample side and a reference side in a sample chamber 430. A sample installation unit 435 for installing a sample container is provided for the sample side. Further, although omitted in the figures, a reference member may be installed on the optical path of the reference side.

The measurement unit 400, on the basis of instructions from the control device 500, operates the light source 410 or the spectrometer 420, and measures the absorbance of a sample extract through a detector 440. Further, the detector 440 calculates concentration from a calibration curve or a factor on the basis of the measured absorbance. Further, although an example using absorbance is shown here, transmittance may be used.

Further, spectral analysis (data processing) using the spectrophotometer system 100 described above can be performed on a UV spectrum, an FL spectrum, or the like of a spectrophotometer. Further, it may also be applied to spectral analysis of a DAD used in HPLC.

### (Detailed Configuration of Control Device (500))

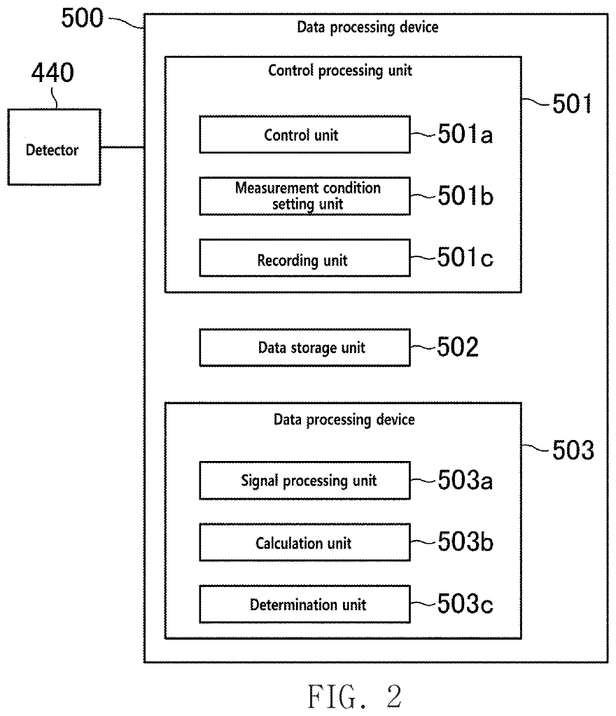

The control device 500, as shown in FIG. 2, includes a control processing unit 501, a data storage unit 502, and a data processing device 503.

The control processing unit 501, which controls the overall operation of the spectrophotometer system 100, includes a control unit 501a, a measurement condition setting unit 501b that sets measurement conditions on the basis of operation of an operation panel (not shown), and a recording unit 501c that records measurement results.

The data storage unit 502 is configured to maintain processed data on the basis of measurement results.

The data processing device 503, which performs processing on the basis of measurement results, functions as a partial regression curve calculation unit and an integrated regression curve calculation unit. Specifically, for example, it includes a signal processing unit 503a that performs D/A conversion or the like of analog signals output from the detector 440, a calculation unit 503b that performs calculation, analysis, or the like of regression curves, and a determination unit 503c that performs determination of analysis results and the like.

### (Data Processing Operation)

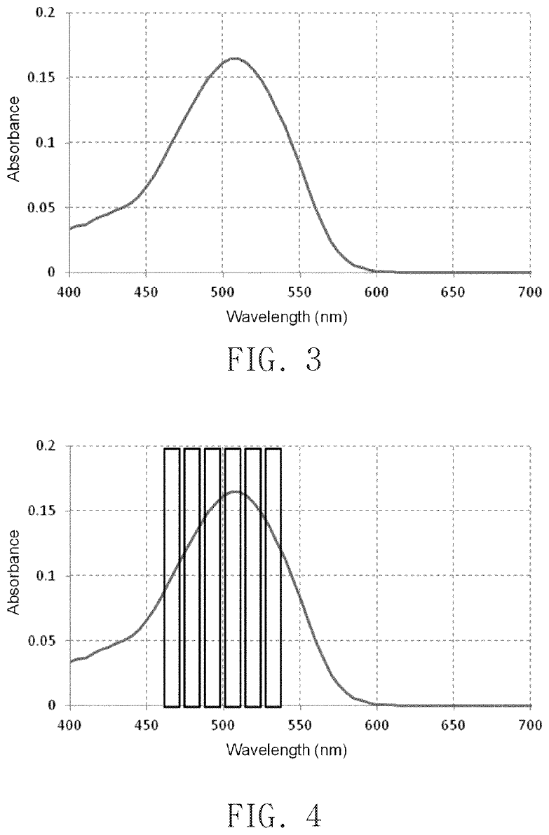

In the spectrophotometer system 100, spectral data, for example, as shown in FIG. 3, are obtained through a measurement operation. This spectral data is spectral data with a wavelength λ on a horizontal axis and absorbance on a vertical axis representing, and is a discrete set of data points. Such spectral data is processed by the PCF (Partial Curve-Fitting) described below, whereby a continuous function f(λ) is obtained.
(1) The spectrum is divided along the horizontal axis (λ) into predetermined wavelength ranges, as shown in FIG. 4; specifically, for example, measured spectrum is divided into strips such as 462.5 to 475 nm, 475 to 487.5 nm, etc. This division may be performed as designated by a user, or may be automatically performed in accordance with a certain algorithmic determination rule. Further, each strip range may not be identical, and the ranges may be determined on the basis of the number of data points. Further, the wavelength ranges are not limited to regions divided not to overlap, and may be wavelength ranges having overlap.

More specifically, for example, as a simple example, it may be possible to preset the number of data points in a strip to 7 points, automatically divide (cut) each strip from the shorter to the longer wavelength so that the strips do not overlap, determine a regression curve for each strip, and finally, smoothly connect the regression curves (strip connection-type PCF method). Further, it may also be possible to sequentially determine regression curves by dividing (cutting out) shifted regions so that partial wavelength ranges have overlapping portions (scanning-type PCF method). Further, as a rule for variably determining the length of a partial wavelength range, for example, when performing regression using a cubic polynomial, regression starts from a 5-point regression range, and if the sum of squared residuals is below a certain threshold, the range may be sequentially increased to 6 points, 7 points, and so on.
(2) The measured data points in each range is regressed by a polynomial curve such as a quadratic or cubic curve, for example, using the least squares method, whereby a plurality of partial regression curves is obtained. Accordingly, the vertical-axis error of the signal intensity is taken into account. Further, curves of third degree or higher functions or Gaussian curves may also be used, and various approximation methods other than the least squares method may be used.
(3) On the basis of each partial regression curve, they are appropriately connected be restored into a continuous waveform, thereby obtaining an integrated regression curve for a wavelength range wider than the partial wavelength ranges. That is, each regression function is smoothly connected so that the resulting regression behaves as if it were a simple single-valued function (injective function). Here, “smoothly” means that, for example, first-order or higher derivatives are also smoothly connected. Accordingly, regardless of the measurement wavelength intervals of the spectrum, a function f(λ) capable of representing a curve that more closely approximates the spectrum is obtained.

More specifically, for example, by using a cubic polynomial f(λ) and ensuring that at a connection point λ₀, f1(λ₀)=f2(λ₀) and the first derivatives (f1′(λ₀)=f2′(λ₀)) are satisfied, the curves can be connected not merely like a broken-line graph, but also without any creases.

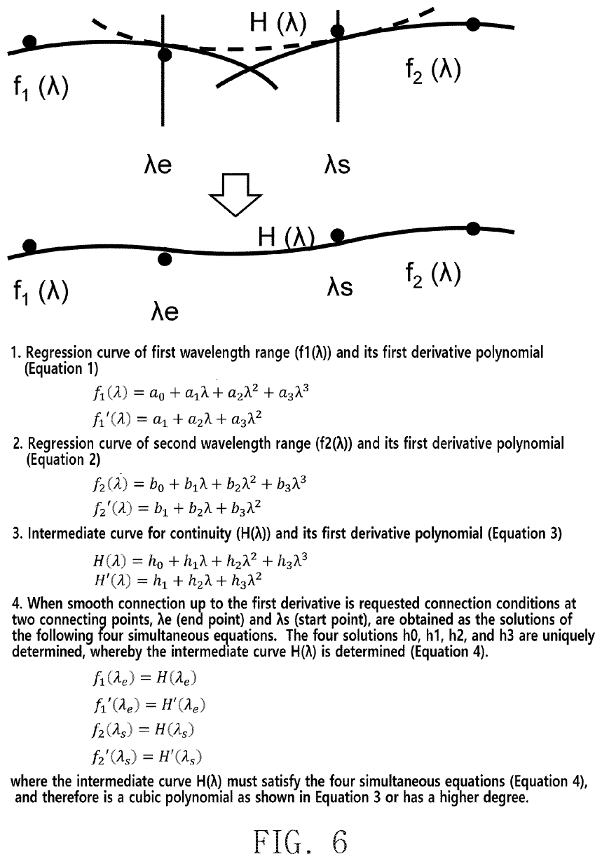

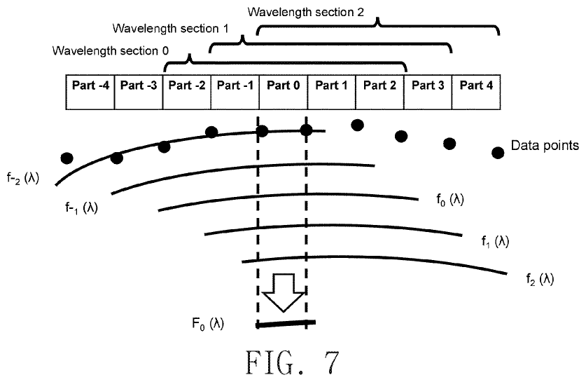

Further, for example, by connecting two regression curves obtained at intervals in the wavelength direction using an intermediate curve such as a polynomial of second or higher order, a continuous waveform may be obtained. Specifically, for example, as shown in FIG. 6, if the time of the last data point in the first wavelength range is λe and the time of the first data point in the second wavelength range is λs, and the connection conditions at each point are set, four simultaneous equations is obtained, as also shown in FIG. 6. By solving this equation, unlike spline interpolation that simply connects data points smoothly, an intermediate curve that considers errors can be easily obtained.

The functional form obtained by the process described above is, for example, output from the data processing device 503. Specifically, a spectrum may be represented as a graph, whereby the extent to which actual data points deviate from a regression curve is shown.

As described above, since a partial regression curve for plot data in a predetermined wavelength range is obtained, characteristic points can be obtained relatively quickly and easily. Further, since regression using a relatively low-degree function can be performed easily, it is also possible to readily suppress biased regression curves due to the influence of noise. In particular, since it is not necessary to select the type of regression curve or to select a wavelength range or a time-axis range for obtaining a regression curve, objective processing can be performed quickly and easily. That is, a spectral waveform curve closer to a true curve with minimized influence of errors can be easily obtained in a functional form.

When a function as described above is obtained, not only the search for differential characteristic points such as maximum points and inflection points, but also comparison with a reference spectrum over a wide wavelength range and wavelength correction shift can be performed easily. Further, the data reliability of a spectral waveform can also be improved mathematically and statistically.

Further, as a result of the above-described functionalization, comparison of spectra can be performed easily. For example, if λ is input at 1 nm intervals across an entire wavelength range to a sample and reference functions f(λ) and g(λ), and the correlation coefficient of the corresponding f(λ) and g(λ) values is calculated, a higher correlation indicates higher sample purity, so it is possible to compare how close the sample spectrum is to the pure reference. Further, in the case of a DAD chromatogram, it is also possible to evaluate the quality of separation and the presence or absence of impurities. That is, the spectra can be compared by regressing both f(λ) and g(λ) with the same function.

Further, the advantage of obtaining a true functional curve f(λ) is that, even if the measured wavelengths of a reference and a sample are different, it is possible to easily bring one closer to the other. That is, for example, if a reference is determined as a functional g(λ) through PCF processing, g(λ) can be calculated for each measured wavelength of a sample even if the sample is measured at arbitrary wavelength intervals, thereby allowing a correlation coefficient to be obtained.

Further, since a true spectrum can be recognized as a waveform curve, if it can be represented as functional output corresponding to input such as a wavelength λ rather than as a plotting method, it is more convenient. As a result, regardless of the measurement wavelength intervals of a spectrum, it is possible to calculate a curve approximating the spectrum as a functional form capable of representing the curve. Therefore, comparison between spectra can be easily performed. Further, since it is a functional form, wavelength correction can be easily performed by shifting λ in the wavelength direction by ±Δλ.

Specifically, for example, when comparing a currently measured spectral waveform with a previously measured reference comparison waveform, even when the wavelength interval at the time of the past measurement is 2 nm, whereas the wavelength interval of current measurement is 1 nm and thus they do not match, these spectral waveforms can be easily compared. Further, even when a difference in accuracy exists in the wavelength direction, i.e., the horizontal axis between a past spectrum and a current spectrum, if the spectra are represented as functional forms, it becomes possible to compare the spectral waveforms by making adjustments such as shifting the wavelength λ by +0.2 nm.

### (Rejection of Outliers)

When regression is performed on the basis of plot data, there are cases where data points, so-called outliers, deviate significantly from the regression curve. In such cases, it may be possible to obtain a regression curve close to the truth one using only a more reliable group of measured data points by setting certain rules for rejecting outliers, performing rejection for each strip, and then performing regression again. By connecting the polynomials of the strips obtained in this manner, it is possible to obtain an outlier-rejection type PCF function f(λ) over the entire wavelength range.

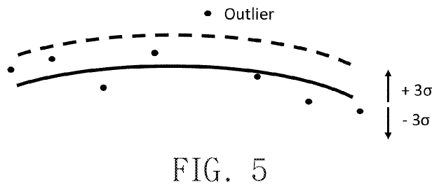

Specifically, for example, as shown in FIG. 5, first, a curve is regressed using all black circular data points. An envelope width of, for example, ±3 σ is set above and below the initial regression curve. If there are outliers that fall outside the envelope range (whose distance from the regression curve is equal to or greater than a predetermined value), those outliers are removed from the data points, and the regression is performed again. By such an outlier removal method, a more reliable regression curve can be obtained.

As described above, since the PCF function assumes the presence of errors, it is easier to obtain a true spectral curve, unlike spline interpolation, which can be regarded as treating actual data as absolute values, and accordingly, the reliability in spectral comparison can be improved. Furthermore, the effect of extrapolation estimation in the wavelength range, which is not available with spline interpolation, can also be expected.

Further, the smoothing process only smooths irregularities near measured data using a moving-average approach, so the plot appears smooth, but the spectral function f(λ) is not directly obtained, and unless spline interpolation is added to the smoothing result, spectral values for arbitrary wavelengths cannot be obtained. However, since the above-mentioned PCF function is obtained, spectral values for arbitrary wavelengths can be easily obtained.

Further, the PCF function may appear similar to one that incorporates spline interpolation into the smoothing process, but the smoothing spline interpolation function does not aim to obtain a true curve, so there is a limit to its accuracy. Further, due to the above difference, in the PCF function, by performing outlier rejection, it is an ideal processing method that facilitates obtaining a true functional form that can never be achieved by the smoothing spline interpolation function.

Further, the PCF function is distinct from the least squares methods that assume a predefined model function, such as Gaussian or Lorentzia. In other words, the advantage of the PCF function is that it can be easily applied to any real waveform because it does not assume a model function for an integrated regression curve for a wavelength range wider than a partial wavelength range.

The PCF function can be applied to both chromatograms and spectra. They are not merely shapes or waveforms in a two-dimensional space. This is because the attributes represented by the vertical axis and the horizontal axis are different. In a chromatogram, the vertical axis represents the intensity of the detected signal and the horizontal axis represents time. In the case of a spectrum, the vertical axis represents the intensity of the detected signal and the horizontal axis represents the wavelength. In both cases, it can be seen that the attributes of the vertical axis and horizontal axis are different.

In the case of shapes in a two-dimensional space, there is no qualitative difference between the vertical axis and the horizontal axis. Therefore, since arbitrary vertical axis and horizontal axis can be set within a two-dimensional space, the same shape can be represented even if the coordinate system is rotated or translated. However, because the attributes of the vertical axis and the horizontal axis are different in chromatograms and spectra, such coordinate transformations cannot be performed.

In other words, the PCF method described above can be applied to measurement devices, such as a spectrophotometer and a chromatograph, where absorbance or transmittance corresponding to a variable that is a wavelength or a time axis is measured.

### (Scanning-Type PCF)

Scanning-type PCF is a PCF method in which regression processing is performed for each wavelength range, shifted by, for example, one data point at a time. For example, a wavelength range encompassing six wavelength data points is assumed. These six wavelength data points do not necessarily need to be arranged at equal intervals along a number line. The spectral intensity of wavelength range 0 in the initial state is regressed, for example, using a cubic polynomial f₀(λ). As shown in FIG. 7, when the number of data points to be grouped is six, wavelength range 0 has five parts, with its center being part 0. Next, wavelength range 1 is reset and regressed to f₁(λ) by shifting only one wavelength data point toward the longer wavelength side. Wavelength range 1 also has five parts, with its center being part 1. Further, similarly, wavelength range 2 is set by shifting the wavelength by one data point to the right, and the six spectral intensity data points are regressed to f₂(λ). Wavelength range 0 can also be shifted by one data point at a time toward the shorter wavelength side, that is, to the right, and they are called wavelength range −1 and wavelength range −2, respectively. In the same way, spectral intensities are regressed in each range, whereby f₋₁(λ) and f₋₂(λ) are also obtained. In FIG. 7, five function waveforms f₋₂(λ) to f₂(λ) are overlaid by giving them different offsets in the vertical direction, and thus are displayed by slightly shifting them along the vertical axis.

As shown in FIG. 7, focusing on the initial wavelength range 0 with wavelength part 0 at the center, there are five regression curves f₋₂(λ), f₋₁(λ), f 0(λ), f₁(λ), and f₂(λ), so a representative function F₀(λ) that represents wavelength part 0 can be obtained by simply averaging them. This averaging may be done as a weighted average, and only f₀(λ) may be redefined as the representative function F₀(λ). Further, the representative functions F₀(λ), F₁(λ), F₂(λ) . . . for respective wavelength parts 0, 1, 2 . . . may be adjusted so that they are smoothly connected at their junction points (for example, so that the values or slopes at the junction points are matched).

Here, a method of skipping one wavelength part at a time and focusing on parts 2, 4, 6, etc. may be applied. That is, for example, if regression processing with one-part shifts is repeated in the same manner, five regression curves also exist for part 2, whereby a representative function F₂(λ) is obtained. Now that F₀(λ) for the wavelength part 0 and F₂(λ) for wavelength part 2 have been obtained, if smooth connection of these is required, an intermediate curve H(λ) shown in FIG. 6 can be introduced. Therefore, a curve smoothly connected in the order F₀(λ), H(λ), F₂(λ) can be obtained. By extending this idea in both positive and negative directions, including negative order numbers −1 and −2, and replacing the regression curves of even-numbered parts and the odd-numbered parts with their respective intermediate curves, a smoothly connected curve can be obtained. This constitutes one example of the scanning-type PCF method.

Further, since an intermediate curve can be smoothly connected without necessarily covering the entire wavelength part, a modified version can be devised. From each of adjacent wavelength parts, the last 10% portion of the preceding part and the first 10% portion of the succeeding part are provided as blank wavelength regions for placing an intermediate curve. Here, 100% refers to the width of one part. In this way, as described above, at the boundary points before and after the blank region, four simultaneous equations can be set up, so it is possible to determine an intermediate curve H(λ). This blank region is a margin-like wavelength region, so it is called a connecting margin. The connecting margin may be the last 10% portion of the preceding part or the first 5% portion of the succeeding part.

The scanning-type PCF method allows a plurality of partial regression curves to be mechanically and smoothly connected via an intermediate curve, so that the decision rules for determining the width of a wavelength range as described above may be unnecessary. Accordingly, a threshold value related to the vertical axis associated with the decision rules may also be unnecessary, which is another feature of the method

### (Connection Margin of Strip Connection-Type PCF)

The PCF method cannot achieve smooth connection using only regression curves, so it is considered that a connecting margin is always necessary to achieve smooth connection. T he respective regression curves can be smoothly connected by fitting an intermediate curve within the wavelength region of that connection margin. Understanding it in this way, in the example of the strip connection-type PCF of FIG. 6, the actual data points λe and λs were used as connecting points, and the two regression curves f₁(λ) and f₂(λ) were connected via the intermediate curve H(λ). However, as a modification, connecting points may be set independently of the end data points λe and λs of both wavelength ranges. For example, a new connecting point 10% shifted to the left from λe may be set.

Conversely, a new connecting point 5% shifted to the right from λs may be set. By shifting the connecting points, the wavelength width between λe and λs, which was 100%, can also be adjusted to any connecting margin width, such as 115%.

### (2-Point Skipping of Scanning-Type PCF)

The scanning-type PCF was explained as shifting the wavelength range by one data point at a time, but a method shifting by two points at a time may also be adopted. In FIG. 7, by shifting two points at a time, three regression curves are obtained from wavelength range −2, wavelength range 0, and wavelength range 2, then averaged, whereby it is possible to determine a representative function F₀(λ). Thereafter, as described above, F ₀(λ), H(λ), and F₂(λ) are connected in order. By repeating this operation, an integrated regression curve can also be obtained.

(Scanning-Type PCF with Decision Rules)

Even for the scanning-type PCF, some users consider it desirable that regression curves connected by an intermediate curve cover a wider wavelength region. In that case, using a certain decision rule, for example, a method of employing a regression curve integrating four parts from part 0 to part 3 shown in FIG. 7 may be adopted. If the sum of squared residuals between the regression curve and the data points is below a certain threshold in the wavelength region integrating part 0 to part 3, and above the threshold in the wavelength region integrating five parts from part 0 to part 4, the search process stops at part 3. In this way, one regression curve integrating four parts from part 0 to part 3 can be determined. Further, then, a wavelength region from part 4 to part 8 is set, and similarly, threshold determination is repeated, thereby determining the regression curve in the rear wavelength region. The new rear regression curve and the front regression curve can be connected via an intermediate curve. The scanning-type PCF method with decision rules can be regarded as a method of gradually extending the width of strips, and can be said to be essentially the same method as the strip connection-type PCF method with decision rules.

### (Intermediate Curve Using Higher-Order Polynomial)

When applying a polynomial to the intermediate curve H(λ), a cubic polynomial has been exemplified as an example, but higher-order polynomials or other functions may also be employed. As described above, in the method for continuously connecting two adjacent regression curves, it was described to solve four simultaneous equations by requiring smooth connection up to a first derivative. If smooth connection up to the 0th, 1st, and 2nd derivatives is required, six simultaneous equations must be solved, and the intermediate curve H(λ) requires a quintic or higher-order polynomial. If the degree of the polynomial is higher than (n−1) for n simultaneous equations, the coefficients of the intermediate curve H(λ) cannot be uniquely determined. In this case, since the polynomial would have variable degrees of freedom, it is desirable to use a polynomial of degree (n−1) for the intermediate curve.

### (Use of Intermediate Curve With One Boundary Point)

In FIG. 6, in the process of smoothly connecting adjacent regression curves, the end point of partial wavelength range 1 when obtaining the front regression curve was denoted as λe and the start point of partial wavelength range 2 when obtaining the rear regression curve was denoted as λs. This explains the case where the boundary between wavelength range 1 and wavelength range 2 consists of a single data point λb. That is, this is a case where wavelength range 1 and wavelength range 2 share the boundary point λb. In this case, for example, the data point immediately to the left of λb is called λb−1, the data point immediately to the right of λb is called λb+1, and an intermediate curve H(λ) can be determined by using λb−1 the connecting point λe, and λb+1 as the connecting point λs. This is a matter of convention, so various methods can be chosen. For example, H(λ) may be determined by using λb as λe and λb+1 as the connecting point λs. Conversely, H(λ) may be determined by using λb−1 as λe and λb as the connecting point λs. Further, the degree of the polynomial may be increased by one, and the condition that it passes through the boundary point λb may be imposed. Further, as described above, a wavelength shifted 10% to the right from λb−1 toward λb may be used as λe, and a wavelength shifted 50% to the left from λb+1 toward λb may be used as λs. In this case, since there is no data point serving as a connecting point, it should be referred to as the connecting boundary λe or λs for determining H(λ).

As an alternative, there is also a method of searching for the intersection λi of the regression curve f1(λ) obtained from wavelength range 1 and the regression curve f2(λ) obtained from wavelength range 2. If λi is found, H(λ) is determined, for example, by using the points closest to the left and right of λi as connecting points λe and λs, respectively. It is also possible to set the connecting boundary λe or λs by shifting by a certain wavelength from λi. Since it would be problematic if λi is too far from the boundary point λb between wavelength range 1 and wavelength range 2, it is desirable to establish a rule such that the wavelength distance between λi and λb does not exceed a certain threshold.

If this λi rule is not satisfied, or if the intersection cannot be found in the first place, H(λ) can be determined using means such as the connecting points λb−1 and λb+1 based on the boundary point λb described above.

### (Use of Intermediate Curve For Overlapping Wavelength Ranges)

A case where wavelength ranges, that is, strips, overlap can also be handled in the same manner. This is the case where the end point λe of partial wavelength range 1 is located behind the start point λs of partial wavelength range 2, that is, on the longer-wavelength side. In this case, after obtaining each regression curve first, an overlapping range may, for example, be set directly as the determination range of H(λ). This is a procedure of determining H(λ) by using the first data point of the overlapping range as λe described above, and the last data point of the overlapping range as λs. Even when an overlapping range exists, it is possible to smoothly connect adjacent regression curves using an intermediate curve, even in cases where wavelength ranges overlap, on the basis of various conventions such as using the intersection λi or shifting a certain wavelength amount by 50% or 0.1 nm from a specific point or boundary.

### (Vertical-Axis Residuals)

According to the present disclosure, residuals appear between data points and a regression curve along the vertical axis whether when obtaining a regression curve or using decision rules based on the sum of squared residuals. The method using an envelope also monitors residuals from a regression curve along the vertical axis. On the other hand, it may be considered that an ideal model without error is employed along the horizontal axis such as wavelength. As can be seen from this explanation, the present disclosure does not deal with geometric shapes or waveforms in two-dimensional space, and it is a point to be noted that the present disclosure deals with chromatograms or spectra having signal intensity on the vertical axis.

What is claimed is:

1. A data processing device of a measurement device, that performs data processing on the basis of plot data measured corresponding to a variable that is a wavelength or a time axis, the data processing device comprising:
a partial regression curve calculation unit configured to obtain a plurality of partial regression curves that are partial regression curves respectively for a plurality of partial variable ranges that are some ranges of the variables; and
an integrated regression curve calculation unit configured to obtain an integrated regression curve for a variable range wider than the partial variable ranges on the basis of the obtained plurality of partial regression curves.

2. The data processing device of claim 1, wherein an intermediate curve connecting the variable ranges is obtained on the basis of partial regression curves for variable ranges spaced apart from each other, and the integrated regression curve is obtained on the basis of the partial regression curves and the intermediate curve.

3. The data processing device of claim 1, wherein for variable ranges that are offset so as to overlap each other, a representative curve representing an overlapping portion of the variable ranges is obtained on the basis of the obtained partial regression curves, and the integrated regression curve is obtained on the basis of the representative curve.

4. The data processing device of claim 3, wherein an intermediate curve connecting the variable ranges is obtained on the basis of the representative curve for the variable ranges spaced apart from each other, and the integrated regression curve is obtained on the basis of the representative curve and the intermediate curve.

5. The data processing device of claim 1, wherein the partial regression curve is any one of a curve of a function of second or higher order or a Gaussian curve.

6. The data processing device of claim 1, wherein the partial regression curve calculation unit, after obtaining the partial regression curves, obtains again partial regression curves, excluding plot data having a distance over a predetermined level from the partial regression curves.

7. A data processing method of a measurement device, that performs data processing on the basis of plot data measured corresponding to a variable that is a wavelength or a time axis, the data processing method comprising:
a partial regression curve calculation step of obtaining a plurality of partial regression curves that are partial regression curves respectively for a plurality of partial variable ranges that are some ranges of the variables; and
an integrated regression curve calculation step of obtaining an integrated regression curve for a variable range wider than the partial variable ranges on the basis of the obtained plurality of partial regression curves.

8. A spectrophotometer system comprising:
a spectrophotometer; and
the data processing device of a measurement device of claim 1.

9. A chromatograph comprising:
a chromatograph unit configured to separately measure components contained in a sample; and
the data processing device of a measurement device of claim 1.
